(19) United States
(12) Patent Application Publication
(10) Pub. No.: US 2011/0135486 A1
(43) Pub. Date: Jun. 9, 2011

(54) BELT OF A ROTOR BLADE OF A WIND POWER PLANT

(75) Inventor: Urs Bendel, Fockbek (DE)

(73) Assignee: REPOWER SYSTEMS AG, Hamburg (DE)

(21) Appl. No.: 12/961,649

(22) Filed: Dec. 7, 2010

(30) Foreign Application Priority Data
Dec. 7, 2009 (DE) 10 2009 047 570.2

(51) Int. Cl. F03D 1/06; B32B 5/28; B32B 7/02

(52) U.S. Cl. 416/230; 428/339; 428/215; 428/114; 428/60

(57) ABSTRACT

A belt (20) of a rotor blade (10) of a wind power plant, that includes a plurality of fiber-reinforced individual layers, which are interconnected by a resin. At least one fiber-reinforced individual layer of the belt has a longitudinal stiffness of more than 50,000 N/mm with a thickness of more than 0.9 mm.

### BACKGROUND OF THE INVENTION

1. Field of the Invention

The invention relates to a belt of a rotor blade of a wind power plant, comprising a plurality of fiber-reinforced individual layers, which are interconnected by a resin.

2. Description of Related Art

A main belt in the rotor blade of a wind power plant is made up of a plurality of individual layers, in order to achieve in particular the longitudinal stiffness necessary for the rotor blade. The necessary longitudinal stiffness results from the loads acting on the rotor blade and, for example, the parameter of the tower clearance, i.e. the distance from the rotor blade tip to the outer wall of the tower. Depending on the size of the rotor blade, different numbers of layers are inserted. Thus, for example, 90 layers of fiber-glass reinforcement are used in a 50-m-long rotor blade. Fiber-reinforced individual layers, which have reinforcing fibers, or respectively a fabric made of corresponding fibers, which have a layer thickness of approx. 0.7 mm with a fiber layer weight of approx. 980 g/m² made of fiber-glass rovings, are normally used in the construction of the main belts of rotor blades. The hardened laminate made of this fabric has an elasticity module in the longitudinal direction of approx. 39,000 N/mm² with a fiber volume content of approx. 50%. The laminate is preferably made of epoxy resin. This results in a longitudinal stiffness of approx. 27,300 N/mm. Alternatively, the main belt can also have carbon-fiber reinforced individual layers, for example, with a thickness of approx. 0.45 mm per individual layer with a fiber areal weight of approx. 500 g/m² from carbon fiber rovings and an elasticity module in the longitudinal direction in the laminate of approx. 128,200 N/mm². The result is a stiffness of approx. 57,690 N/mm. The stiffness and/or longitudinal stiffness results from the multiplication of the elasticity module with the thickness of the individual layer.

For one, the use of this type of fiber-reinforced individual layers has the disadvantage that the manufacture of the main belts takes a lot of time. It is also disadvantageous that, in particular, belts made of carbon fiber or respectively carbon fiber rovings are very expensive.

### BRIEF SUMMARY OF THE INVENTION

The object of the present invention is to specify cost-effective and quickly producible belts for rotor blades of a wind power plant that in particular do not need carbon fibers.

This object is solved by a belt of a rotor blade of a wind power plant, comprising a plurality of fiber-reinforced individual layers, which are interconnected by a resin, wherein at least one fiber-reinforced individual layer has a longitudinal stiffness of more than 50,000 N/mm with a thickness of more than 0.9 mm.

The belt is preferably a or the main belt of a rotor blade, wherein it or respectively they are arranged, for example, on the suction side inside on the blade shell and/or on the pressure side inside on the blade shell.

A fiber-reinforced individual layer comprises a fabric of rovings, which are placed next to and on top of each other and thus create the corresponding thickness of the individual layer, wherein the fabrics are correspondingly sewn or respectively knitted. Woven fabrics can also be used. However, they are somewhat more expensive, which is why sewn fabrics or respectively knitted fabrics are preferred. The individual layer preferably has a fiber volume content of 50% to 60% and apart from that comprises a resin. The plurality of fiber-reinforced individual layers is correspondingly interconnected by the resin.

The used resins are in particular synthetic resins or reaction resins, which are manufactured synthetically through polymerization, polyaddition or polycondensation reactions. The synthetic resins, used preferably, as a rule consist of two main components, namely a resin and a hardener, which together result in the reactive resin mass or respectively the reactive resin. The viscosity increases through hardening and, after hardening is complete, a corresponding composite of resin with the fibers in the individual layers and a composite of the several individual layers amongst each other are obtained. Within the framework of the invention, the term “resin” also includes a resin with a hardener.

The belt, or respectively main belt, can also be divided in the longitudinal extension of the rotor blade. In particular, DE 10 2009 03 31 65 of the applicant is referred to for this. In particular, the belt mainly has the contour of the rotor blade in the area in which the respective belt is arranged in the rotor blade. This means that the belt extends accordingly in the longitudinal and axial direction of the rotor blade or in the longitudinal extension and is curved and twisted there according to the rotor blade, wherein the twist represents, in particular, a type of twisting around the longitudinal axis or respectively around the longitudinal extension and the curve is in particular a type of wringing or squeezing of the rotor blade toward the longitudinal axis. The belt is, thus, accordingly also preferably “flexed” or respectively in particular also “twisted.”

The belt is preferably produced using a plastics technology. At least one resin and at least one fiber layer is hereby used, in particular a fiber glass layer or basalt fiber layer. A resin transfer molding (RTM) technique or a resin infusion molding (RIM) technique can be used for production, in particular a vacuum-assisted resin (VAR) infusion technique and/or a laminating technique, for example with so-called prepregs.

Almost all individual layers preferably have a longitudinal stiffness of more than 50,000 N/mm with a respective thickness of more than 0.9 mm

The longitudinal stiffness of the individual layer is preferably greater than 60,000 N/mm, in particular greater than 70,000 N/mm, in particular greater than 80,000 N/mm, in particular greater than 90,000 N/mm, in particular greater than 100,000 N/mm. The longitudinal stiffness of the individual layer can, preferably, be up to 150,000 N/mm.

When using fiber glass rovings in the individual layer, the longitudinal stiffness is preferably in the range of 50,000 N/mm to 150,000 N/mm, in particular in a range between 70,000 N/mm and 110,000 N/mm. When using basalt rovings in the individual layer, the longitudinal stiffness preferably lies in a range between 70,000 N/mm and 150,000 N/mm, in particular between 90,000 N/mm and 120,000 N/mm.

The thickness of the individual layers is, preferably, greater than or equal to 0.95 mm, in particular greater than or equal to 1.5 mm, in particular greater than or equal to 2.0 mm, in particular greater than or equal to 2.5 mm. The thickness of the individual layer can, preferably, be in particular up to 5 mm. An especially preferred thickness is 2.6 mm for a fiber-glass fabric and 0.95 mm for a basalt fabric. The fibers of the fiber-reinforced individual layers are preferably made of glass fibers and/or basalt fibers. Furthermore, the individual layer is preferably mainly a unidirectional fiber fabric, in which more than 80%, in particular more than 89%, of the fibers are aligned in the longitudinal direction of the belt.

The weight per unit area of the individual layer is preferably more than 1,000 g/m², in particular more than 2,000 g/m², in particular more than 3,000 g/m², in particular more than 3,500 g/m². The fiber areal weight is the weight of a fiber surface on 1 m² in grams, wherein the fibers are not saturated with resin. The fiber areal weight is in particular preferably a maximum of 4,000 g/m². The weight of a fiber layer preferably lies in the range of 1,000 g/m² to 4,000 g/m², in particular preferably between 2,000 g/m² and 3,500 g/m².

The belt is preferably designed without carbon fibers and without aramid fibers or alternatively mainly without carbon fibers and mainly without aramid fibers. Within the framework of the invention, “mainly without these fibers” means in particular that the share of these fibers compared to other fibers is less than 5%. Naturally, the variant without carbon fibers and without aramid fibers is particularly preferred. A very cost-effective production of corresponding belts is hereby possible.

The individual layer is preferably designed as a prepreg. Within the framework of the invention, a prepreg is, in particular, the short form for pre-impregnated fibers. It is a fiber fabric that is pre-saturated with resin. In this respect, it is a fiber matrix semi-finished product, which is generally known in rotor blade construction.

It is especially preferred if at least one layer end of an individual layer is joined using a scarf joint or butt-jointed and in particular cut out in a zigzag manner. A delamination on the layer ends or respectively on one layer end of the individual layers or respectively of the belt is very efficiently counteracted hereby. Joining an individual layer by using a scarf joint or butt-joint is in particular a beveling of the individual layer, in particular a tapering to the end of the individual layer. Preferably, the plurality of fiber-reinforced individual layers in the belt are joined using a scarf joint or a butt-joint or respectively beveled to the end of the belt, i.e. designed tapered, so that there is one bevel or respectively scarf joint of the belt towards at least one end of the belt. Delamination problems are hereby mainly avoided. A corresponding scarf joint or respectively beveling can be given in that the layer ends of the individual layers, and namely, in particular, of each individual layer, are cut out in the form of a zigzag so that the rovings of the individual layers can be distributed accordingly so that a thinning of the individual layer takes place toward the end of the individual layer. An even thinning toward the end, i.e. an approximately even beveling or respectively bevel, results from the use of a zigzag cut.

An additional layer on the layer end of the belt is preferably applied, in particular laminated, over the ends that are joined using a scarf joint or that are beveled. A delamination is hereby avoided even better. Joining using a scarf joint is also understood, in particular, as a beveling. Through the beveling, joining using a scarf joint or respectively in particular also through the cutting out in zigzag form, and namely in a direction of the belt inserted into the rotor blade from the profile leading edge to the profile trailing edge, the individual fibers or respectively rovings in the respective layer can give way slightly to the side so that the layer thickness is continuously reduced. The resistance level of the individual layer against delamination is hereby considerably increased and the use of very thick layers is, thus, also simplified. Through the additional layer on the layer end, which covers the layer ends, a lateral gradation is created instead of a height gradation, which preferably smears during an infusion.

A rotor blade of a wind power plant is, preferably, provided with at least one belt according to the invention. The rotor blade preferably has a longitudinal extension, which extends from a rotor blade root mainly to a rotor blade tip, wherein an aerodynamic cross-sectional profile is provided at least in an area of the rotor blade, which has a profile leading edge (nose) and a profile trailing edge, which are interconnected via a suction side and a pressure side of the cross-sectional profile.

Within the framework of the invention, a belt or respectively the main belt is an important load-bearing element of a rotor blade, which is designed to receive impact forces, torques and/or bending forces. A belt is, in particular, a fiber-glass-reinforced plastic fabric, which with several layers, in particular made of fiber-glass mats or other fiber fabrics, alone or in combination with other fibers like basalt fibers or made solely of basalt fibers, leads to a corresponding stability in connection with a polyester resin or an epoxy resin or another resin. The thickness of the belt depends on the blade length and the load parameters calculated for one position or location of a wind power plant. The thickness can, thus, lie in the range of 2 cm to 10 cm. A width of the belt can correspondingly be provided in the range of 5 cm to 50 cm or even wider. Two belts that together form a belt pair, which can then together have a width of up to 1 m, can also be used. In particular, DE 10 2009 033 165 of the applicant is referenced for this.

The belt is preferably a main belt, which extends mainly from a rotor blade root up to a rotor blade tip, wherein fewer than 60 individual layers, in particular fewer than 50 individual layers, in particular fewer than 40 individual layers, in particular fewer than 30 individual layers, are provided in the belt. More than 20 individual layers are preferably provided. 20 to 60 individual layers, in particular preferably 30 to 50 individual layers, are preferably provided.

The belt preferably has a length of more than 30 m, in particular more than 35 m, in particular more than 40 m, in particular more than 45 m, in particular more than 50 m. The length of the belt is preferably up to 70 m. A belt length of 30 m to 70 m, in particular 35 m to 60 m, in particular 40 m to 50 m, is preferably provided in particular.

### BRIEF DESCRIPTION OF THE DRAWINGS

The invention is described below, without restricting the general intent of the invention, based on exemplary embodiments in reference to the drawings, whereby we expressly refer to the drawings with regard to the disclosure of all details according to the invention that are not explained in greater detail in the text. The figures show in:

FIG. 1 a schematic three-dimensional representation of a rotor blade,

FIG. 2 a schematic sectional view of a manufacturing mold for the production of a belt with an already accordingly produced belt,

FIG. 3 a schematic inner view of a part of a rotor blade, and

FIG. 4 a schematic sectional representation along cut A-A of FIG. 3.

### DETAILED DESCRIPTION OF THE INVENTION

In the following figures, the same or similar types of elements or respectively corresponding parts are provided with the same reference numbers, in order to prevent the item from needing to be reintroduced.

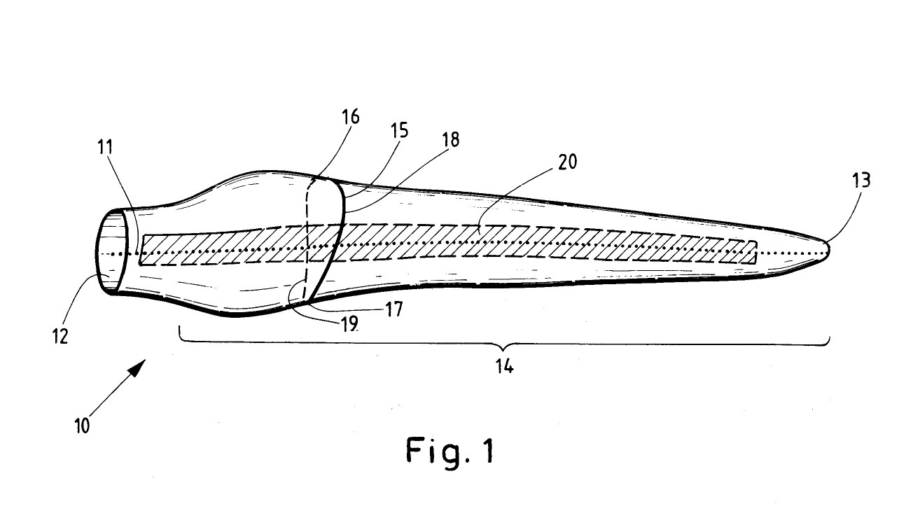

FIG. 1 shows schematically a rotor blade 10 of a wind power plant. The rotor blade 10 extends along its longitudinal extension 11 from a rotor blade root 12 to a rotor blade tip 13. In an aerodynamic area 14, cross-sectional profiles 15 are provided that extend from a profile leading edge 16 (nose) to a profile trailing edge 17, wherein the profile leading edge 16 and the profile trailing edge 17 separate a suction side 18 and a pressure side 19 of the rotor blade 10.

In order to stabilize the rotor blade 10, a belt 20 is provided, which receives the main forces, which act on the rotor blade. The belt 20 extends mainly from the rotor blade root 12 to mainly the rotor blade tip 13. The belt 20 can also extend fully from the rotor blade root 12 almost fully up to the rotor blade tip 13. However, the belt normally ends slightly before the rotor blade tip 13. The belt 20 can also be located at an angle to the longitudinal extension 11.

The invention now provides for the usage of a belt 20 for rotor blades, which has fewer fiber-reinforced layers 21-21′″, but which are instead thicker than usual and have a comparatively higher longitudinal stiffness.

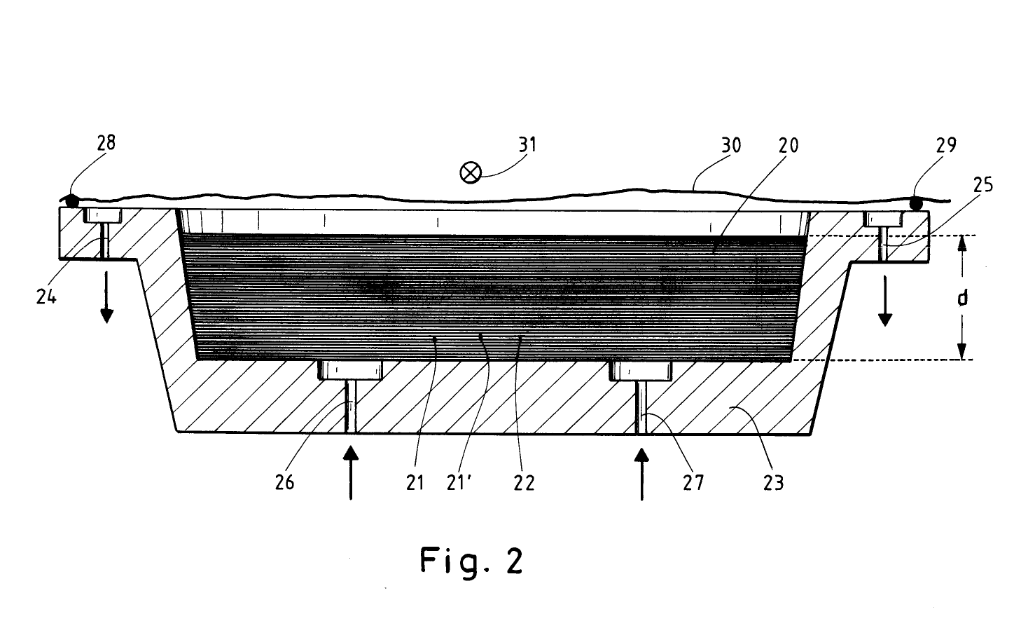

For example, FIG. 2 shows a belt 20 in a schematic sectional representation arranged in a manufacturing mold 23. The belt 20 comprises 43 individual layers 21-21′″. These individual layers 21-21′″ have a fabric made of, for example, glass fibers or basalt fibers, which are aligned mainly unidirectional in the longitudinal direction 31. In order to form a corresponding composite, resin 22 has been inserted accordingly into the fabrics. This can occur, for example, through a vacuum-supported infusion technique as indicated in FIG. 2.

The belt is produced accordingly such that, for example, prepreg layers, in this case 43 prepreg layers, are stacked above each other or dry fiber-glass layers, which have a thickness according to the invention. A vacuum foil 30 is then placed over the manufacturing mold 23, namely on seals 28 and 29. Resin, e.g. epoxy resin, is then made available for the resin sprue connections 26 and 27 and vacuum is applied to the vacuum connections 24 and 25. Resin is hereby suctioned into the manufacturing mold 23 and, thus, into the fabric or respectively into the belt 20 to be produced. As soon as the uppermost one is also accordingly completely impregnated with resin, the vacuum pump is switched off and the belt can harden. A corresponding belt 20 with a thickness d results.

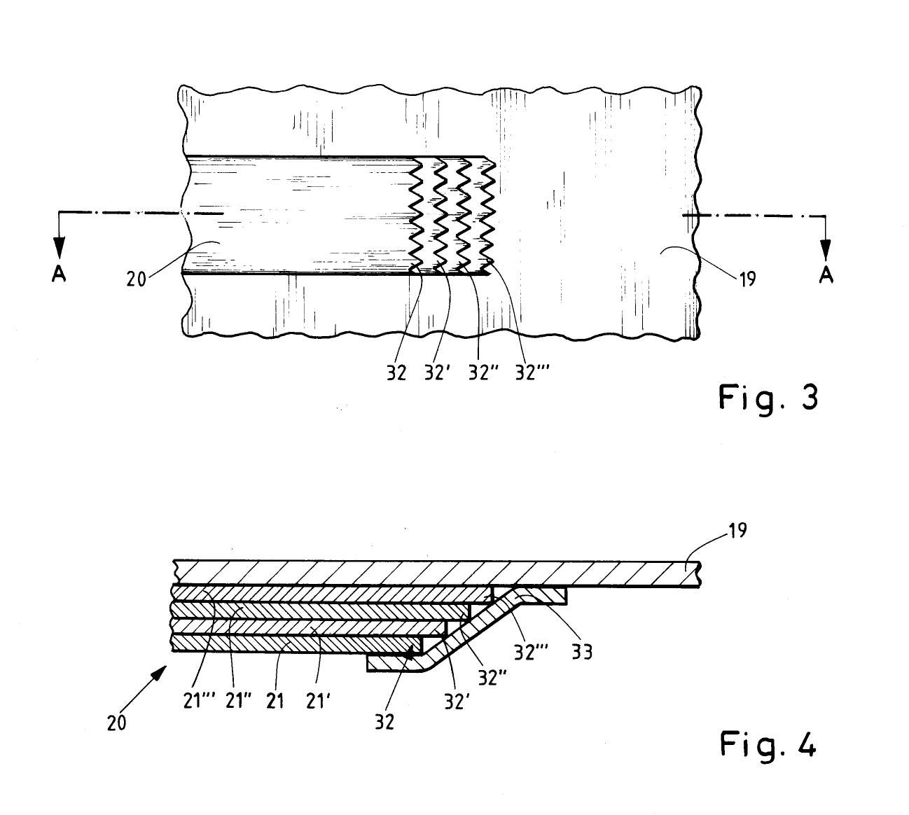

FIG. 3 shows schematically a top view of a part of a rotor blade from the inside. The belt 20 is applied on the pressure side 19 from inside. On the respective layer end 32, 32′, 32″, 32′″, the corresponding layers 21-21′″ are cut off in a zigzag manner or respectively toothed or serrated. The respective layers in the end area hereby give way slightly to the side so that a scarf joint or respectively a bevel in the layer thickness results in the end area 32-32′″. The risk of delamination can hereby be counteracted very well.

FIG. 4 shows a schematic sectional view along cut A-A in FIG. 3. For better visualization, the cover layer 33 was not shown in FIG. 3 but is now shown in FIG. 4.

For simplification, only four individual layers 21-21′″ are shown in FIGS. 3 and 4. In particular, the delamination can also be counteracted by the cover layer. It extends beyond the end areas of the individual layers 21 through 21′″ towards the inside of the pressure side 19 of the rotor blade.

The belt, according to the invention, is characterized by fiber-reinforced individual layers with a much higher stiffness than used before, wherein conventional fibers like glass fibers and/or basalt fibers are used in particular.

In a first variant, fiber-glass prepregs are used, which are aligned unidirectionally, i.e. more than 90% of the fibers are aligned in the longitudinal direction 31. They have, for example, a thickness of approx. 1.3 mm and an E module or modules of elasticity in the longitudinal direction of approx. 40,000 N/mm² with a weight per unit area of 1,650 g/m² of glass fibers. This hereby results in a stiffness of 52,000 N/mm.

In another variant, a fiber-glass prepreg or respectively several corresponding prepregs with unidirectional fibers with a respective thickness of approx. 2.6 mm is used. The fiber-reinforced individual layer has an elasticity module in the longitudinal direction of approx. 40,000 N/mm² with a weight per unit area of 3,300 g/mm² for the glass fibers alone. This hereby results in a stiffness of 104,000 N/mm.

In another variant, a dry fiber-glass fabric with unidirectional fibers was used, which has a weight per unit area of fibers of 3,800 g/m². This fiber-reinforced individual layer then has an average thickness of approx. 3 mm when 40 individual layers are used. The elasticity module in the longitudinal direction was approximately 40,000 N/mm². This resulted in a stiffness of 120,000 N/mm. The last variant was used for a 46-m-long rotor blade.

The first variant was designed with 60 individual layers for a blade approx. 60 m long.

In a fourth variant, a basalt-fiber prepreg was used, which has unidirectionally aligned basalt fibers, i.e. approximately 90% of the fibers are aligned in the longitudinal direction. The prepregs had a thickness of approx. 0.95 mm and an elasticity module in the longitudinal direction of approx. 70,000 N/mm². Furthermore, the basalt fibers had a weight per unit area of 1,200 g/m². This results in a longitudinal stiffness of 66,200 N/mm.

In a fifth variant, a basalt-fiber prepreg with a thickness of 1.1 mm with unidirectional basalt fibers was used, in which an elasticity module was provided in the longitudinal direction of 80,000 N/mm². This results in a longitudinal stiffness of 88,000 N/mm per individual layer.

In a sixth variant, a basalt-fiber prepreg with a thickness of 1.5 mm with unidirectional basalt fibers was used, in which an elasticity module was provided in the longitudinal direction of 100,000 N/mm². This results in a longitudinal stiffness of 150,000 N/mm per individual layer.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics.

### LIST OF REFERENCES

10 Rotor blade
11 Longitudinal extension
12 Rotor blade root
13 Rotor blade tip
14 Aerodynamic area
15 Cross-sectional profile
16 Profile leading edge
17 Profile trailing edge
18 Suction side
19 Pressure side
20 Belt
21, 21′ 21″, 21′″ Fiber-reinforced individual layer
22 Resin
23 Manufacturing mold
24 Vacuum connection
25 Vacuum connection
26 Resin sprue connection
27 Resin sprue connection
28 Seal
29 Seal
30 Vacuum foil
31 Longitudinal direction
32, 32′, 32″, 32′″ Layer end
33 Cover layer
d Thickness

1. Belt (20) of a rotor blade (10) of a wind power plant, comprising:
a plurality of fiber-reinforced individual layers (21, 21′, 21″, 21′″), which are interconnected by a resin (22),
wherein at least one fiber-reinforced individual layer (21-21′″) has a longitudinal stiffness of more than 50,000 N/mm with a thickness of more than 0.9 mm.

2. Belt (20) according to claim 1, wherein mainly all individual layers (21-21′″) respectively have a longitudinal stiffness of more than 50,000 N/mm, with a respective thickness of more than 0.9 mm.

3. Belt (20) according to claim 1, wherein the longitudinal stiffness of the individual layer (21-21′″) is greater than 60,000 N/mm.

4. Belt (20) according to claim 1, wherein the thickness of the individual layer (21-21′″) is greater than or equal to 0.95 mm.

5. Belt (20) according to claim 1, wherein the fibers of the fiber-reinforced individual layers (21-21′″) are glass fibers and/or basalt fibers.

6. Belt (20) according to claim 1, wherein the individual layers (21-21′″) are mainly a unidirectional fiber fabric, in which more than 80%, of the fibers are arranged in the longitudinal direction (31) of the belt (20).

7. Belt (20) according to claim 1 wherein the fiber areal weight of the individual layer (21-21′″) is more than 1,000 g/m2.

8. Belt (20) according to claim 1, wherein the belt (20) is designed without carbon fibers and without aramid fibers or alternatively mainly without carbon fibers and mainly without aramid fibers.

9. Belt (20) according to claim 1, wherein the individual layer (21-21′″) is designed as a prepreg.

10. Belt (20) according to claim 1, wherein at least one layer end (32-32′″) of an individual layer (21-21′″) is butt-jointed, and in particular cut out in a zigzag manner.

11. Rotor blade (10) of a wind power plant with at least one belt according to claim 1.

12. Rotor blade (10) according to claim 11, wherein the belt (20) is a main belt, which extends mainly from a rotor blade root (12) up to a rotor blade tip (13), wherein less than 60 individual layers (21-21′″), are provided in the belt (20).

13. Rotor blade (10) according to claim 11, wherein the belt (20) has a length of more than 30 m.
